(19) United States
(12) Patent Application Publication
(10) Pub. No.: US 2008/0030077 A1
(43) Pub. Date: Feb. 7, 2008

(54) MULTI-STAGE POWER CONVERSION AND DISTRIBUTION

(75) Inventors: Dennis M. Tiry, Palm Harbor, FL (US); Grant L. Smith, Tampa, FL (US); Nelson M. Bier, Clearwater, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/470,035

(22) Filed: Sep. 5, 2006

Related U.S. Application Data
(60) Provisional application No. 60/806,184, filed on Jun. 29, 2006.

(51) Int. Cl. H02J 1/10

(52) U.S. Cl. 307/43

(57) ABSTRACT

A multi-stage power converter is disclosed. The multi-stage power converter includes at least one power source and at least one intermediate down-converter, the at least one intermediate down-converter configured to down convert a voltage output from the at least one power source to an intermediate voltage. The multi-stage power converter further includes one or more point of load converters configured to further convert the intermediate voltage to one or more component voltages applicable to one or more sets of processing components.

This application claims the benefit of U.S. Provisional Application No. 60/806,184, filed on Jun. 29, 2006, which is incorporated herein by reference in its entirety.

### GOVERNMENT INTEREST STATEMENT

The U.S. Government may have certain rights in the present invention as provided for by the terms of a restricted government contract.

### BACKGROUND

In one type of space application, a device traveling in space transmits data to a device located on Earth. Examples of a device traveling in space (a “space device”) include, without limitation, a satellite and a space vehicle. An example of a device located on Earth (an “Earth-bound device”) is a mission control center. Data that is transmitted from a space device to an Earth-bound device is also referred to here as “downstream” or “payload” data. Examples of a typical space payload system include, without limitation, a mission control center recording scientific data obtained from one or more sensors or other scientific instruments included in or on a space device.

The typical space payload system is often comprised of multiple processing elements partitioned onto one or more electronic subassemblies. The system operates with high amounts of communication interference, and is especially susceptible to high amounts of radiation. The sub-micron radiation tolerant integrated circuits typically employed by the space payload system require high current, low voltage power. Conversion and distribution of high currents at low voltages from a centralized power converter inherently cause significant voltage drops, along with power losses and heat dissipation that are not viable in any space payload application. To achieve suitable performance levels, the space payload system requires an overall payload power efficiency that exceeds the efficiencies typically achieved with traditional power conversion and distribution methods.

### SUMMARY

The following specification addresses multi-stage power conversion and distribution that limits current levels for low voltage electronic devices. Particularly, in one embodiment, a multi-stage power converter is provided. The multi-stage power converter includes at least one power source and at least one intermediate down-converter, the at least one intermediate down-converter configured to down convert a voltage output from the at least one power source to an intermediate voltage. The multi-stage power converter further includes one or more point of load converters configured to further convert the intermediate voltage to one or more component voltages applicable to one or more sets of processing components.

### DRAWINGS

These and other features, aspects, and advantages will become better understood with regard to the following description, appended claims, and accompanying drawings where:

FIG. 1 is a block diagram of an embodiment of a space system;

FIG. 2 is a block diagram of an embodiment of a payload processing subsystem within the space system of FIG. 1 that incorporates multi-stage power conversion and distribution; and

FIG. 3 is a block diagram of an alternate embodiment of a payload processing subsystem within the space system of FIG. 1 that incorporates multi-stage power conversion and distribution.

Like reference numbers and designations in the various drawings indicate like elements.

### DETAILED DESCRIPTION

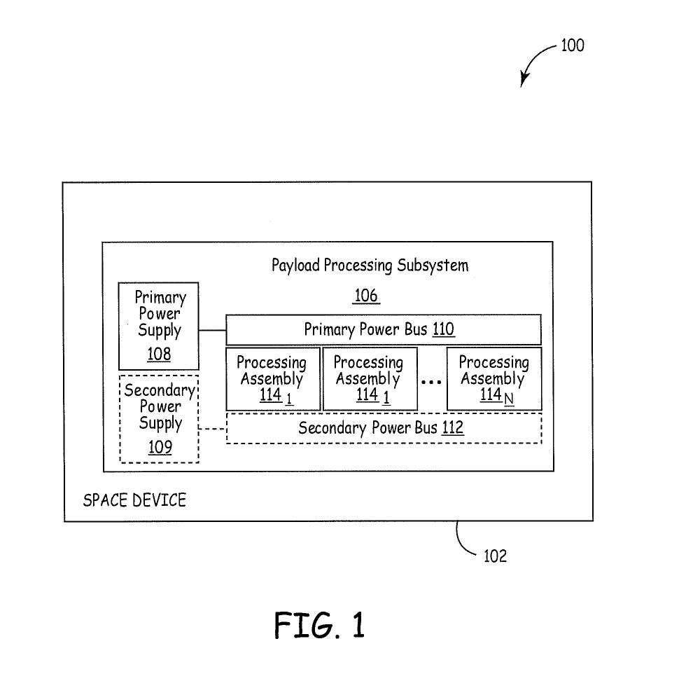

FIG. 1 is a block diagram of an embodiment of a space system 100. In the example embodiment of FIG. 1, the space system 100 comprises a space device 102. In one implementation, the space device 102 represents a satellite, a space vehicle, and the like that provides payload data to one or more Earth-bound devices (not shown). The space device 102 further includes a payload processing subsystem 106. Within the payload processing subsystem 106, a primary power bus 110 is powered by at least one primary power supply 108. In one implementation, the payload processing subsystem 106 includes at least one secondary (redundant) power bus 112 (indicated in FIG. 1 as optional) powered by at least one optional secondary power supply 109.

The payload processing subsystem 106 further comprises processing assemblies 114₁ to 114_{N}. In the example embodiment of FIG. 1, the processing assemblies 114₁ to 114_{N} are connected together by the primary power bus 110. In one implementation, the processing assemblies 114₁ to 114_{N} are further connected together by the (optional) secondary power bus 112. The primary power bus 110 (the optional secondary power bus 112) serves as an interconnecting power distribution bus between the processing assemblies 114₁ to 114_{N} and within the payload processing subsystem 106. It is understood that the space device 102 is capable of accommodating any appropriate number of the processing assemblies 114 (for example, one or more processing assemblies 114) in a single space device 102.

In operation, the payload processing subsystem 106 processes payload data for the space device 102. In one implementation, one or more sets of processing components reside on each processing assembly 114. The one or more sets of processing components comprise, without limitation, radiation-tolerant electronic computing elements including application-specific integrated circuits (ASICs), field-programmable gate arrays (FPGAs), field-programmable object arrays (FPOAs), programmable logic devices, signal processors, and input/output (I/O) modules. In addition, there are ancillary (auxiliary) support components required to operate the space device 102. The ancillary support components include, without limitation, a plurality of power-on-reset circuits, I/O drivers and receivers, oscillators, and clock circuits that consume electrical power.

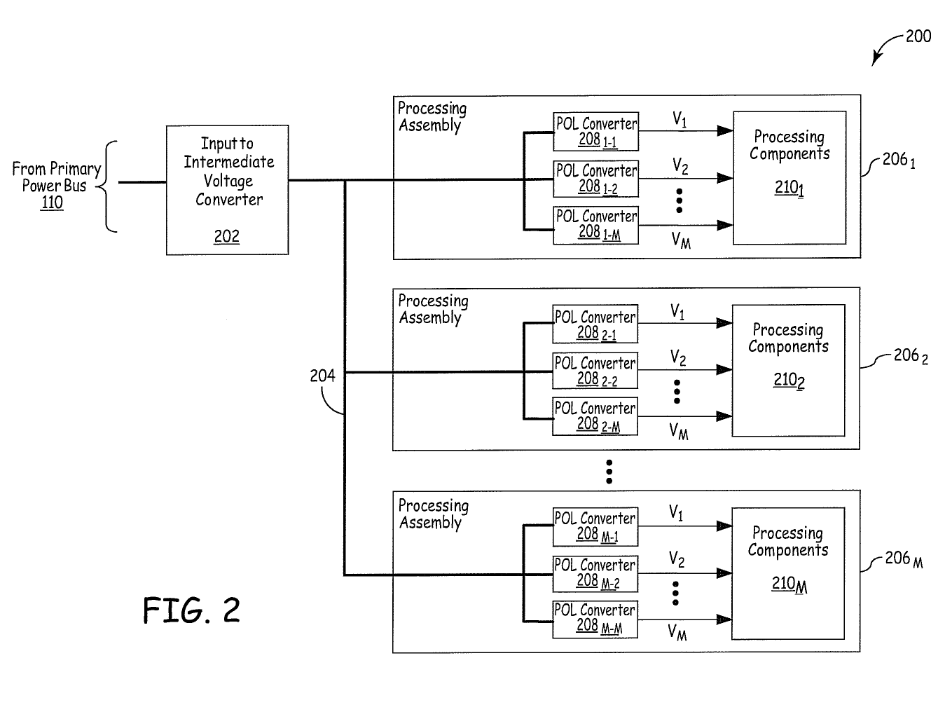

The payload processing subsystem 106 requires a substantial amount of electrical power for operating under radiation-tolerant environmental conditions. The substantial amount of electrical power is obtained without raising a set point of the at least one primary power supply 108 (the at least one secondary power supply 109) to compensate for voltage drops. Further, corresponding current draws from the at least one primary power supply 108 (the at least one secondary power supply 109) require the payload processing subsystem 106 to maintain a voltage regulation of about +/−5% for the one or more sets of processing components residing on each processing assembly 114. In the example embodiment of FIG. 1, at least one multi-stage power converter in the payload processing subsystem 106 maintains a requisite power distribution efficiency level for the radiation-tolerant electronic computing elements of the space device 102. The at least one multi-stage power converter, discussed in further detail below with respect to FIG. 2, is an intermediate DC to DC power converter (down-converter). At least one output of the down converter is distributed within the payload processing subsystem 106 as an intermediate voltage. The intermediate voltage allows the voltage regulation for the plurality of processing elements (residing on each of the processing assemblies 114) to be performed directly on each of the processing assemblies 114.

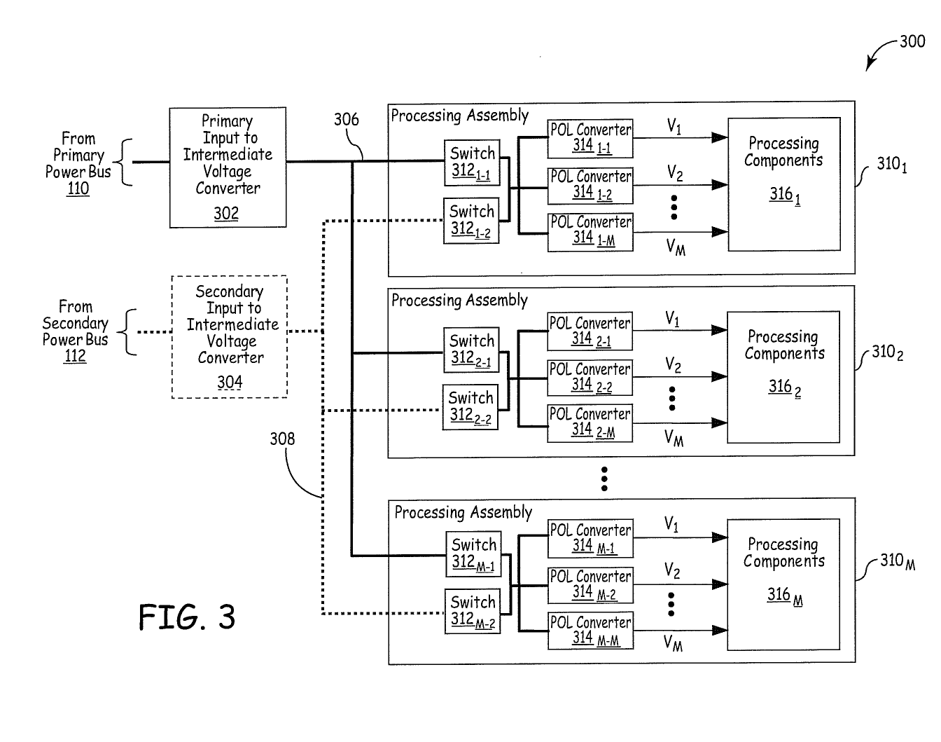

The payload processing subsystem 106 further includes one or more radiation-tolerant point of load (POL) converters (discussed in further detail below with respect to FIGS. 2 and 3) that converts the intermediate voltage to one or more component voltages applicable for the one or more sets of processing components residing on each processing assembly 114. In one implementation, the intermediate voltage is within a range of 5 to 15 V DC. Alternate ranges are possible. The intermediate voltage in the payload processing subsystem 106 reduces operating current levels and substantially eliminates very high (detrimental) currents from affecting the plurality of radiation-tolerant electronic computing elements within the space device 102. In one implementation, the detrimental currents include any current level at or above 100 A.

FIG. 2 is a block diagram of an embodiment of a payload processing subsystem 200 within the space system 100 of FIG. 1 that incorporates multi-stage power conversion and distribution. In the example embodiment of FIG. 2, the payload processing subsystem 200 represents one implementation of the payload processing subsystem 106 of FIG. 1. The payload processing subsystem 200 comprises an input to intermediate voltage converter 202 coupled to processing assemblies 206₁ to 206_{M} by an intermediate voltage bus 204. It is noted that for simplicity in description, a total of three processing assemblies 206 are shown in FIG. 2. However, it is understood that in other embodiments of the payload processing subsystem 200, different numbers of processing assemblies 206 (for example, one or more processing assemblies 206) are used.

The processing assemblies 206₁ to 206_{M} further include a series of POL converters 208₁₋₁ to 208_{1-M}, 208₂₋₁ to 208_{2-M}, and 208_{M-1} to 208_{M-M} coupled to corresponding sets of radiation-tolerant processing components 210₁ to 210_{M}. It is noted that for simplicity in description, a total of three POL converters 208 are shown in each processing assembly 206 of FIG. 2. However, it is understood that in other embodiments of the payload processing subsystem 200 and the processing assemblies 206, different numbers of POL converters 208 (for example, one or more POL converters 208) are used. In the example embodiment of FIG. 2, each of the POL converters 208 are step-down (buck) controllers that supply a plurality of component voltages (noted as V₁ to V_{M} in FIG. 2) applicable to each set of radiation-tolerant processing components 210₁ to 210_{M}. As illustrated in FIG. 2, each of the POL converters 208 supply a specific component voltage V₁ to V_{M}. It is noted that for simplicity in description, a total of three sets of radiation-tolerant processing components 210 are shown in each processing assembly 206 of FIG. 2. However, it is understood that in other embodiments of the processing assemblies 206, a different number of sets of radiation-tolerant processing components 210 (for example, one or more sets of radiation-tolerant processing components 210) are used.

As discussed above with respect to FIG. 1, the intermediate voltage on the intermediate voltage bus 204 comprises a possible range of 5 to 15 V, with a corresponding current level range of 5 to 10 A. In the same (or alternate) implementation(s), the plurality of radiation-tolerant component voltages comprises a range of 0.8 V for V₁, 1 V for V₂, and up to 2.5 V for V_{M}. Alternate values for the plurality of radiation-tolerant component voltages are possible. In some embodiments, the POL converters 208 are physically located on the same printed wiring assembly boards (PWBAs) that house the processing components 210 they supply. In the example embodiment of FIG. 2, the placement of the input to intermediate voltage converter 202 provides a localized power isolation of at least 1 MΩ and suitable electromagnetic interference (EMI) rejection. In one implementation, the input to intermediate voltage converter 202 substantially eliminates any low frequency EMI effects on the payload processing subsystem 200. Due to the localized electrical isolation provided by the input to intermediate voltage converter 202, the POL converters 208 do not require separate electrical isolation.

In operation, the power bus 110 supplies electrical power to radiation-tolerant processing components 210₁ to 210_{M} over multiple stages. A first stage involves converting at least one input voltage from the power bus 110 to an intermediate voltage by the intermediate voltage converter 202. The intermediate voltage bus 204 distributes the intermediate voltage to the series of POL converters 208. At a second stage, the series of POL converters 208 convert the intermediate voltage into a plurality of component voltages for each set of radiation-tolerant processing components 210₁ to 210_{M}. As discussed earlier with respect to FIG. 1, the POL converters 208 complete the voltage regulation of the plurality of component voltages for each set of radiation-tolerant processing components 210. In the example embodiment of FIG. 2, converting the at least one input voltage to the intermediate voltage eliminates a need for voltage regulation at each set of radiation-tolerant processing components 210₁ to 210_{M}. In the same embodiment, the intermediate voltage bus 204 reduces current levels for the plurality of radiation-tolerant component voltages from over 100 A to about 5 to 10 A (that is, by at least a factor of 5). This reduction in operating current levels further results in less heat dissipation from each of the processing assemblies 206.

The input to intermediate voltage converter 202 develops an output of 5 V from a 28 V input present on the primary input power bus 110 at an efficiency level of at least 90%. The at least 90% efficiency level of the input to intermediate voltage converter 202 ensures the suitability of the payload processing subsystem 200 for space systems (that is, systems employing radiation-tolerant components). The input to intermediate voltage converter 202 employs certain designs to attain this level of efficiency. These designs include, but are not limited to, synchronous output rectification with one or more MOSFET switches, tuned switching of transformer input MOSFETs (to make use of transformer-tuned inductive characteristics to decrease MOSFET turn-on losses), magnetics with inductors and the transformer integrated in one core (to lower conductor current, lowering IR losses), special physical design of the magnetics to allow use of thicker conductors (to lower IR losses), and at least one circuit board layout of the input to intermediate voltage converter 202 to minimize all power conductor circuit path lengths.

In one implementation, the POL converters 208 are located as close as physically possible to the processing components 210 on each processing assembly 206. For this implementation, an exemplary footprint area for the POL converter 208 is approximately 3.8 cm by 5.1 cm, with an efficiency level of at least 85%. In the example embodiment of FIG. 2, an overall power distribution efficiency results from a two-stage combination of the input to intermediate voltage converter 202 and the POL converters 208. In one implementation, by multiplying the effective efficiencies of the two stages together, the overall power distribution efficiency level is at least 70%, taking into account any interconnection and power switching losses from within the space device 102. This overall power distribution efficiency level reduces (and, in at least one embodiment, substantially eliminates) any detrimental effects of very high operating current levels on the radiation-tolerant processing components 210₁ to 210_{M}.

As noted above, FIGS. 1 and 2 illustrate at least one embodiment of the space system 100 and the payload processing subsystem 200 incorporating multi-stage power conversion and distribution, respectively. It is to be understood that other embodiments are implemented in other ways. Indeed, the payload processing subsystem 200 illustrated in FIGS. 1 and 2 is adaptable for a wide variety of applications, including radiation-tolerant payload processing subsystems. For example, FIG. 3 is a block diagram of an alternative embodiment of the payload processing subsystem 200, a payload processing subsystem 300, with an (optional) secondary power distribution backplane, the secondary power bus 112 of FIG. 1. The embodiment of the payload processing subsystem 300 shown in FIG. 3 includes at least three processing assemblies 310 with at least three sets of two switches 312 coupled to at least three sets of three POL converters 314, each. The three processing assemblies 310 are individually referenced in FIG. 3 as processing assemblies 310₁, 310₂, and 310_{M}, respectively. The three sets of POL converters 314 are individually referenced in FIG. 3 as POL converters 314₁₋₁ to 314_{1-M} (processing assembly 310₁), 314₂₋₁ to 314_{2-M} (processing assembly 310₂), and 314_{M-1} to 314_{M-M} (processing assembly 310_{M}), respectively. The two switches 312 are individually referenced in FIG. 3 as switch 312₁₋₁ to 314₁₋₂ (processing assembly 310₁), 312₂₋₁ to 314₂₋₂ (processing assembly 310₂), and 312_{M-1} to 314_{M-2} (processing assembly 310_{M}), respectively. It is understood that the payload processing subsystem 300 is capable of accommodating any appropriate number of the processing assemblies 310, the POL converters 314, and the switches 312 (for example, at least one processing assembly 310, at least one set of three POL converters 314, and at least one set of two switches 312) in a single payload processing subsystem 300.

The payload processing subsystem 300 further comprises at least one primary input to intermediate voltage converter 302, at least one secondary input to intermediate voltage converter 304, at least one primary intermediate voltage bus 306, and at least one secondary intermediate voltage bus 308. Similar to the payload processing subsystem 200 of FIG. 2, the at least one primary input to intermediate voltage converter 302 receives a primary input voltage from the primary power bus 110 of FIG. 1. The at least one primary input to intermediate voltage converter 302 transfers an intermediate primary voltage value on the at least one primary intermediate voltage bus 306 to each of the switches 312₁. The at least one secondary input to intermediate voltage converter 304 receives a secondary (redundant) input voltage from the secondary power bus 112 of FIG. 1. The at least one secondary input to intermediate voltage converter 304 transfers an intermediate secondary voltage value on the at least one secondary intermediate voltage bus 308 to each of the switches 312₂.

In the example embodiment of FIG. 3, the payload processing subsystem 300 includes an optional power distribution redundancy for the space device 102 of FIG. 1. The optional power distribution redundancy includes the sets of switches 312 for removing power from a detected faulty source (for example, the primary power bus 110 of FIG. 1) and applying power from a redundant source (for example, the secondary power bus 112 of FIG. 1) to substitute for the detected faulty source. In the example embodiment of FIG. 3, the switches 312 are located directly on each of the processing assemblies 310. In similar embodiments, routing from any of the switches 312 to the POL converters 314 is minimized. In one implementation, each of the switches 312 comprises a single n-channel power MOSFET with its normal polarity reversed and enhanced with a voltage high enough to turn it fully on. Alternate implementations of ON/OFF control for the switches 312 comprise active low (active high) digital logic level commands from the appropriate processing assemblies 310. The single n-channel power MOSFET used in each of the switches 312 offers efficiency greater than or equal to 90%. In one or more implementations of the switches 312, reversal of normal polarity is used when the secondary power bus 112 is used by the space device 102 of FIG. 1 as a redundant power bus. The reversal prevents an intrinsic diode from back-feeding into the secondary power bus 112 when the secondary power bus 112 is in an OFF state.

This description has been presented for purposes of illustration, and is not intended to be exhaustive or limited to the form (or forms) disclosed. Variations and modifications may occur, which fall within the scope of the embodiments described above, as set forth in the following claims.

What is claimed is:

1. A multi-stage power converter, comprising:
at least one power source;
at least one intermediate down-converter configured to down convert a voltage output from the at least one power source to an intermediate voltage; and
one or more point of load converters configured to further convert the intermediate voltage to one or more component voltages applicable to one or more sets of processing components.

2. The converter of claim 1, wherein the at least one power source comprises a primary power source.

3. The converter of claim 1, wherein the at least one intermediate down-converter further comprises at least one intermediate voltage bus.

4. The converter of claim 3, wherein the at least one intermediate voltage bus further comprises at least one power switch between the at least one intermediate down-converter and the one or more point of load converters.

5. The converter of claim 1, wherein the one or more point of load converters and the one or more sets of processing components are mounted on a single processing assembly.

6. The converter of claim 5, wherein the single processing assembly is a radiation-hardened processing assembly.

7. A method for supplying power to one or more radiation-hardened electronic computing elements, the method comprising:
at a first stage, converting at least one input voltage to an intermediate voltage;
distributing the intermediate voltage to one or more point of load converters; and
at a second stage, converting the intermediate voltage into a plurality of voltages applicable for each of the one or more radiation-hardened electronic computing elements.

8. The method of claim 7, wherein converting the at least one input voltage further comprises maintaining a power distribution efficiency level of at least 90%.

9. The method of claim 7, wherein distributing the intermediate voltage further comprises supplying the intermediate voltage to the one or more point of load converters on at least one intermediate voltage bus.

10. The method of claim 7, wherein distributing the intermediate voltage further comprises switching between at least one primary power source and at least one secondary (redundant) power source.

11. The method of claim 7, wherein converting the intermediate voltage further comprises:
regulating the plurality of voltages for each of the one or more radiation-hardened electronic computing elements; and
reducing current levels on the plurality of voltages by at least a factor of 5.

12. A system, comprising:
at least one space device; and
a payload processing subsystem within the at least one space device, the payload processing subsystem including:
one or more power sources,
one or more payload processing assemblies within the payload processing subsystem, and
at least one multi-stage power converter coupled to the one or more power sources, the at least one multi-stage power converter operating at an efficiency level above 90%.

13. The system of claim 12, wherein the at least one space device comprises a radiation-hardened space device.

14. The system of claim 12, wherein the payload processing subsystem further comprises at least one intermediate power bus coupled to the at least one multi-stage power converter.

15. The system of claim 12, wherein the payload processing subsystem further comprises:
at least one primary power supply;
at least one secondary (redundant) power supply;
at least one primary power bus coupled to the at least one primary power supply; and
at least one secondary power bus coupled to the at least one secondary (redundant) power supply.

16. The system of claim 12, wherein the one or more payload processing assemblies further comprise:
at least one set of payload processing components; and
one or more point of load converters coupled to the at least one set of payload processing components.

17. The system of claim 16, wherein each of the one or more point of load converters down converts an intermediate voltage to one or more component voltages applicable for the at least one set of payload processing components.

18. The system of claim 16, wherein each of the one or more point of load converters and the at least one set of payload processing components are mounted on a single printed wiring board assembly.

19. The system of claim 16, wherein the one or more payload processing assemblies further include at least one set of power switches between the at least one multi-stage power converter and the one or more point of load converters.

20. The system of claim 19, wherein the at least one set of power switches comprise a set of single n-channel power MOSFETs.
